(19) United States
(12) Patent Application Publication
(10) Pub. No.: US 2023/0368188 A1
(43) Pub. Date: Nov. 16, 2023

(54) System, Method, and Apparatus for Decentralized Authentication and Sale of a Product

(71) Applicants: Christopher Leonardo Price, South Bend, IN (US); Rocky Mudaliar, Blind Bay (CA); Dominic Bilodeau, Irvine, CA (US); Sean Chang, Flushing, NY (US)

(72) Inventors: Christopher Leonardo Price, South Bend, IN (US); Rocky Mudaliar, Blind Bay (CA); Dominic Bilodeau, Irvine, CA (US); Sean Chang, Flushing, NY (US)

(21) Appl. No.: 17/742,133

(22) Filed: May 11, 2022

(51) Int. Cl. G06Q 20/36; G06Q 30/06

(52) U.S. Cl. CPC G06Q 20/3678; G06Q 30/0609; G06Q 30/0637

(57) ABSTRACT

A system, method, and apparatus for decentralized authentication and sale of a product is provided that, in some embodiments, comprises a distributed ledger, a first computing device associated with at least one real-world product owner, and a second computing device associated with a buyer. The distributed ledger generates and links a digital product identifier to at least one real-world product, wherein the digital product identifier is physically affixed to the at least one real-world product. The first computing device stores at least one owner digital wallet, receive at least one unit of currency, and transfer the digital product identifier. The second computing device stores at least one buyer digital wallet, transfers the at least one unit of currency, and receives the digital product identifier. The distributed ledger also determines one or more spatial parameters and generates and transmits a spatial output responsive to a spatial output request.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to authentication of products and more particularly, to a decentralized system, method and apparatus for improving identification of product provenance.

### BACKGROUND

Collecting physical objects has long provided a pastime for many individuals. With the advent of recent technology, this inclination has transitioned to the collection of unique digitally owned assets that are uniquely tied to an individual’s physical identity. Indeed, certain technologies have been developed to render and attach a digital identifier to an object in a manual process through machine learning and artificial intelligence. However, these systems and methods often involve specialized and complicated steps and lack spatial awareness of other nearby devices. Such a task is further complicated by the difficulty in rendering spatially aware digital distributed ledger-based assets to real-world products.

Some have proposed solutions to address these and other problems associated with the transfer of digital and real-world assets alike. For instance, U.S. Pat. Application Publication Nos. 2020/0337162 and 2020/0333421 to Perkins et al. teaches a mounting base for a wirelessly locatable tag and a fastener with a constrained retention ring, respectively. By way of further example, U.S. Pat. No. 10,505,726 to Andon et al. teaches a system and method for providing cryptographically secured digital assets. Still, these have not sufficiently addressed the problems, and there remains a need for a system for decentralized authentication and sale of a product that is secure and improves confidence in product provenance.

### SUMMARY

The present disclosure is directed to a system, method, and apparatus for decentralized authentication and sale of a product. According to this system, method, and apparatus, products, which may include real-world products, virtual products, or even services, may be exchanged directly between product owners and buyers on a networked platform. The system, method, and apparatus may operate on a distributed ledger, such as a blockchain, and may therefore, immutably execute and authenticate such commercial transactions. Certain aspects of the invention discussed herein may further improve the identification of product provenance through one or more spatial parameters.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the decentralized computing system and apparatus may comprise a distributed ledger, a first computing device associated with at least one real-world product owner, and a second computing device associated with a buyer. In some embodiments, the distributed ledger may be a block chain, however, it will be understood that other forms of distributed ledgers may be implemented in accordance with this invention. Moreover, throughout this disclosure, authentication and a sale of a product, or a real-world product, is discussed but a person of ordinary skill in the art will recognize that this system, method, and apparatus may also apply to virtual products or even services and therefore, should not be limited to real-world products.

The distributed ledger may be operative to generate and link a digital product identifier to at least one real-world product. In certain embodiments, the digital product identifier may also be physically affixed to the at least one real-world product. The distributed ledger may also be operative to generate and link a digital owner identifier to at least one real-world product owner. In some embodiments, the at least one real-world product may be a physical product. The physical product may comprise an autographed product, which may comprise at least one autograph. In some of these embodiments, the at least one real-world product owner may create the at least one autograph.

Further, the distributed ledger may be operative to generate at least one owner digital wallet, wherein the at least one owner digital wallet may be associated with the at least one real-world product owner. The distributed ledger may also be operative to store the digital product identifier in the at least one owner digital wallet. The distributed ledger may be further operative to generate at least one buyer digital wallet, which may be associated with the buyer. At least one unit of currency may be stored in the at least one buyer digital wallet.

In certain embodiments, the distributed ledger may determine one or more spatial parameters of the at least one real-world product. The one or more spatial parameters may comprise one or more of a distance between objects, including the at least one real-world product, a geographical location, and an orientation. The distributed ledger may then be operative to generate a spatial output based on the one or more spatial parameters and may also, transmit the spatial output responsive to a spatial output request. The second computing device may be operative to generate and transmit the spatial output request. The second computing device may also be operative to receive the spatial output.

The first computing device may be associated with the at least one real-world product owner. Alternatively, the first computing device may be associated with at least one seller, which may or may not be the at least one real-world product owner. The first computing device may be operative to store at least one real-world product listing in the at least one owner digital wallet. The at least one real-world product listing may correspond to the at least one real-world product. The first computing device may also transmit the at least one real-world product listing.

The first computing device may be further operative to receive and accept a purchase request from the second computing device associated with the buyer. The first computing device may be operative to receive the at least one unit of currency and transfer the digital product identifier to the at least one buyer digital wallet. In some embodiments, the at least one unit of currency may be received in exchange for the transfer of the digital product identifier.

The second computing device may be operative to store the at least one unit of currency in the at least one buyer digital wallet. The second computing device may also be operative to display the at least one real-world product listing. In turn, the second computing device may be operative to generate and transmit the purchase request for the at least one real-world product. Responsive to the first computing device accepting the purchase request, the second computing device may transfer the at least one unit of currency to the at least one owner digital wallet. Then, the second computing device may be operative to receive and store the digital product identifier in the at least one buyer digital wallet.

As previously mentioned, in some embodiments, the distributed ledger may be a blockchain. In some of these embodiments, the distributed ledger may be operative to chain a first new ownership data block to a previous ownership data block. The first new ownership data block may correspond to the transfer of the digital product identifier to the at least one buyer digital wallet. Further, in connection with any subsequent transfers of the digital product identifier, the distributed ledger may be operative to chain a second (third, fourth, and so on) new ownership data block to the previous ownership data block.

In one embodiment of the present invention, a method for decentralized authentication and sale of a product may comprise the steps of: generating and linking, on a distributed ledger, a digital product identifier to at least one real-world product; generating and linking, on the distributed ledger, a digital owner identifier to at least one real-world product owner; generating, on the distributed ledger, at least one owner digital wallet; storing, on the distributed ledger, the digital product identifier in the at least one owner digital wallet; generating, on the distributed ledger, at least one buyer digital wallet; storing, on the distributed ledger, at least one unit of currency in the at least one buyer digital wallet; storing, on the distributed ledger, at least one real-world product listing in the at least owner digital wallet; storing, on the distributed ledger, at least one unit of currency in the at least one buyer digital wallet; transmitting, on a first computing device associated with the at least one real-world product owner, the at least one real-world product listing; displaying, on a second computing device associated with a buyer, the at least one real-world product listing; generating and transmitting, on the second computing device, a purchase request; receiving and accepting, on the first computing device, the purchase request; transferring, on the second computing device, the at least one unit of currency from the at least one buyer digital wallet; receiving, on the first computing device, the at least one unit of currency in the at least one owner digital wallet; transferring, on the first computing device, the digital product identifier; and receiving and storing, on the second computing device, the digital product identifier in the at least one buyer digital wallet.

In further embodiments, the method may also comprise the steps of: determining, on the distributed ledger, one or more spatial parameters of the at least one real-world product; generating and transmitting, on the second computing device, a spatial output request; receiving, on the distributed ledger, the spatial output request; transmitting, on the distributed ledger, the spatial output; and receiving, on the second computing device, the spatial output.

In still further embodiments, and as discussed above, the distributed ledger may be a blockchain. In these embodiments, the method may further comprise the steps of: chaining, on the blockchain, a first new ownership data block to a previous ownership data block. The first new ownership data block may correspond to the transfer of the digital product identifier to the at least one buyer digital wallet.

It is contemplated that providing the system, method, and apparatus for decentralized authentication and sale of a product according to the disclosure and claims provided below may facilitate the authentication and sale of real-world products. It is further contemplated that providing the foregoing system, method, and apparatus may streamline such verification of product provenance because the digital product identifier may be physically affixed to the at least one real-world product.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a block diagram of a networked environment in which an exemplary embodiment of a system for decentralized authentication and sale of a product is implemented.

FIG. 2 illustrates an exemplary embodiment of a computing device shown in FIG. 1.

FIG. 3 is a flowchart illustrating an exemplary embodiment of a method for decentralized authentication and sale of a product.

FIG. 4 is a flowchart illustrating an exemplary embodiment of a method for decentralized authentication and sale of a product.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

The present invention, in some embodiments, may comprise a decentralized electronic database distributed across various computers, or “nodes.” Full, lightweight (or simply “light”) nodes, client and submitting-client, peer, endorser, orderer, and/or ordering-service nodes are collectively referred to herein as “nodes” unless otherwise specified. The decentralized database may securely store and transmit data between computers, other electronic devices, and/or one or more nodes. The present invention may provide that when a new data record, such as a transaction, is created, it may link to the user’s previous data record in the manner known in the block chain database art by using the storage information and chain-creation logarithms or instructions within the data record. By way of non-limiting example, the “genesis” block of a particular blockchain may contain a hash comprising its time and date of creation, at least one element of data (content, usage, rights data or cryptocurrency ownership) and a computer-solvable problem that, when solved, allows another block to link to the present block. Similarly, all other blocks on the blockchain in question may then comprise the previous block’s hash, a hash comprising that block’s time and date of creation, at least one element of data (content, usage, rights data or cryptocurrency ownership) and a computer-solvable problem that, when solved, allows another block to link to the present block.

In some embodiments, the present invention contemplates a separate blockchain for a cryptocurrency ledger that records cryptocurrency transfers and ownership data, content of all types (thereby ensuring the content’s integrity), and content usage by users. In some embodiments, the present invention may process data from one type of blockchain (i.e. usage) and cause a change in one or more other blockchains (i.e. may record a related cryptocurrency transfer on the cryptocurrency ledger blockchain). In some embodiments, any blockchain may comprise any combination of data types. For example, a digital rights management tool may comprise a blockchain containing content, usage, and rights data within the data blocks. Or, in some embodiments, the digital rights management tool may comprise three separate blockchains for content, usage, and rights data. In some embodiments, the present invention may utilize one or more digital rights management tools and one or more cryptocurrency systems and ledgers in tandem or in combination.

By creating a linked series of immutable data records, the present invention may provide a secure chain of data records. As discussed more fully herein, the chain information may comprise one or more cryptographic hashes. For example, if the second data record contains the first data record’s hash, the link between the two may be verified. By creating a new hash for each data record, and including that hash in the second data record, the present invention may provide for a traceable chain of data records.

The present invention may use real-world objects such as data matrix codes (or quick response “QR” codes) as private keys that “unlock” or decrypt a set of data when a user scans the QR code. A non-limiting application of this may be a physical “wallet” bearing a QR code that corresponds to a user’s cryptocurrency account.

In some embodiments, a node may be any suitable electronic device, such as but not limited to a server, a mobile device, or desktop computer, that is linked to one or more networks provided by the present invention and that may perform the functions of the present invention, such as storing, linking block-to-block (“chaining” and thereby creating a link in a blockchain), encrypting, decrypting, and transmitting data. Each node may be configured to independently and automatically verify, update, link, and store each record.

The blockchain database of the present invention may utilize various cooperative or decentralized computing principles. In some embodiments, the blockchain database of the present invention may utilize principles or techniques drawn from cloud computing, thin-cloud computing, fog computing, or even “blockcloud” computing. The present invention may provide that the software, systems, methods, applications, computer programs, and so forth required to execute one or more instructions, methods, computer programs, or functions of the present invention may be stored on nodes, a cloud, thin cloud, fog, or blockcloud server structure.

The present invention may also provide for one or more interface elements, such as by way of illustration and not limitation, a desktop software program, a mobile application, or a website, that enables the user or, in some embodiments, a member of the public, to view one or more elements of a data record. By way of illustration and not limitation, a website may host an interface, wherein a login action could take a user to an individual’s webpage. On the webpage, the present invention may describe or link to one or more elements of the individual’s data record. By way of illustration and not limitation, such a page may contain a randomized identifier, the present data record’s hash, a link to the data record’s previous hash, and one or more links to one or more elements of user-specific data. In some embodiments, when viewed by a member of the general public, the webpage and the data record information may be hidden, randomized, or otherwise unreadable. Or in some embodiments, when viewed by a member of the general public, the webpage and the data record information may be deidentified but otherwise viewable. In some embodiments, when “unlocked” via the QR code, the data record may display unencrypted versions of the user-specific data, along with the hashes.

The present invention may comprise some elements of traditional block chain database encryption, storage, management, and access. The present invention may also make use of other, more widely-used technologies, such as cloud computing, emails, and text messages. The present invention may also draw upon, digitize, or otherwise incorporate paper documents in some embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

The present disclosure is directed to a system, method, and apparatus for decentralized authentication and sale of a product, that is, an online database and means for exchanging and authenticated goods and services directly between buyers and product owners/sellers.

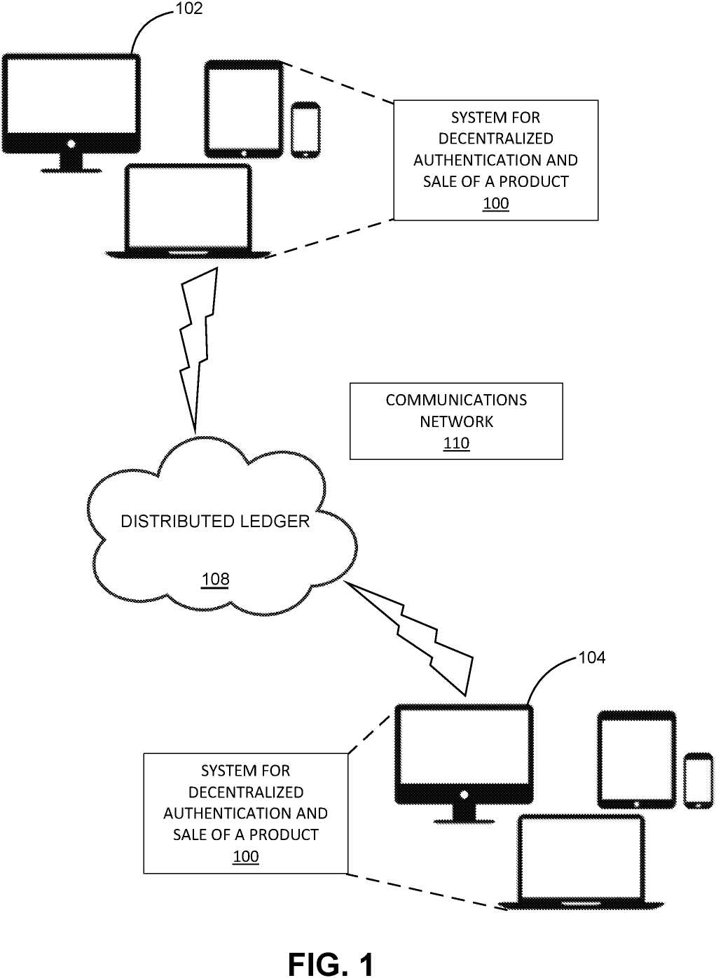

FIG. 1 is illustrative of an exemplary embodiment of a system, method, and apparatus for decentralized authentication and sale of a product 100 which includes a plurality of computing devices communicatively coupled to one another. By way of example, and not limitation, FIG. 1 illustrates a first computing device associated with at least one real-world product owner 102 and a second computing device associated with a buyer 104 that incorporate the system for decentralized authentication and sale of a product. Each of the first computing device 102 and the second computing device 104 may be communicatively coupled via a communications network 110 and exemplary distributed ledger 108. The first computing device 102 and the second computing device 104 may be embodied as any computing device, for example and without limitation, a mobile computing device such as a smartphone or tablet computer that incorporate cellular telephone functionality, or a laptop computer or desktop computer.

Notably, the communications network 110 may use one or more of various communications types, such as, for example and without limitation, short range device-to-device wireless data transfer (i.e. Bluetooth), BLE, ZigBee, Z-Wave, 6LoWPAN, Thread, WiFi-ah (HaLow), 2G (GSM), 3G, 4G, LTE Cat 0, LTE Cat 1, LTE Cat 2, LTE Cat 3, LTE-MN1, NB-IoT, 5G, NFC, RFID, SigFox, LoRaWAN, Ingenu, Weightless-N, Weightless-P, Weightless-W, ANT & ANT+, DigiMesh, MiWi, EnOcean, Dash7, WirelessHART, Ultra-wideband (UWB), and other network protocols, cellular, or Wi-Fi communications. In some embodiments, one or more nodes (not pictured) may take the place of one or more computing devices 102, 104. Communications network may serve to communicatively couple, link, or transfer data between one or more of computing devices 102, 104 and any node with the distributed ledger 108.

Users of the first computing device 102 and the second computing device 104 may be users of at least one distributed ledger 108 known to those skilled in the art. For instance, as noted above, the distributed ledger 108 may comprise a peer-to-peer network, a cloud-based computing network, a fog computing network, a blockcloud computing network, or another blockchain-configured database known in the art capable of secure or unsecure data transfer. In some embodiments, the distributed ledger 108 may be facilitated by a website that may require a registration and login prior to use. Moreover, the distributed ledger 108 may be substituted for any distributed ledger known to those skilled in the art.

In one embodiment, a data record may be stored in multiple copies across the distributed ledger 108 on one or more nodes. While not separately pictured, any of one or more of the first computing device 102 or the second computing device 104 may serve as one or more nodes. In some embodiments, each node may contain and run the software, hardware, firmware, or any other component, necessary to run the present invention. More specifically, each node may provide for a computer system that may run the program of the present invention, create, store, and link (or “chain”) data records to other data records. Each node may also provide for computational power sufficient to perform hash functions, other one-way encryption functions, two-way encryption functions, public key encryption functions and programs, symmetric encryption and symmetric key encryption functions and programs, along with any other function that may be used or provided for by the present invention.

In brief, the original or “genesis” data record may comprise, at least, a hash that records a timestamp representing the data record’s creation date and time (along with, in some embodiments, other information), encrypted user-specific data, and instructions for the linking of the second data record to the present data record. In some embodiments, the instructions may comprise a mathematical problem to be solved. In some embodiments, the present invention may provide that the solution is provided to one or more nodes in the distributed ledger 108. In some embodiments, some or all of the nodes in the distributed ledger 108 may be equally able to solve the instructions, and therefore some or all of the nodes may discover the solution at roughly the same time, thus ensuring uniformity of record-keeping across blockchain- configured database 108. Additional data records may be linked to the genesis data record, and may comprise a new timestamp hash unique to that data record, the previous data record’s hash, encrypted updated user-specific data, and instructions for the next block as detailed elsewhere herein.

The distributed ledger 108 may also be configured to associate a data record, and user-specific data within the data record, with a digital owner identifier. For example, the digital owner identifier may be a QR code. In some embodiments, the digital owner identifier may be stored and displayed on the first computing device 102 or another computing device. The digital owner identifier may be scanned by another computing device, such as the second computing device 104, configured to work with the present invention. In such a configuration, the digital owner identifier may be used as a real-world product owner’s private key and may, when scanned, cause the present invention to unlock, decrypt, or otherwise permit access to one or more items of user-specific data.

The distributed ledger 108 may be operative to generate and link a digital product identifier to at least one real-world product. In certain embodiments, the digital product identifier may also be physically affixed to the at least one real-world product. By way of example, and not limitation, the digital product identifier may comprise a QR code, an RFID tag, or be formed via a laser marking system. The distributed ledger may also be operative to generate and link the digital owner identifier to at least one real-world product owner.

According to certain embodiments, the at least one real-world product may be a physical product. In alternate embodiments, the at least one real-world product may comprise a service. In still other embodiments, though the at least one real-world product may be referred to herein as “real-world,” the at least one real-world product may comprise a virtual product or a virtual service. In embodiments where the at least one real-world product comprises a physical product, the physical product may comprise an autographed product. The autographed product may comprise at least one autograph. In some of these embodiments, the at least one real-world product owner may create the at least one autograph.

The distributed ledger 108 may be further operative to generate at least one owner digital wallet and at least one buyer digital wallet. In these embodiments, the at least one owner wallet may be associated with the at least one real-world product owner and the at least one buyer digital wallet may be associated with the buyer. The distributed ledger 108 may be operative to store the digital product identifier in the at least one owner digital wallet and store at least one unit of currency in the at least one buyer digital wallet.

In certain further embodiments, the distributed ledger 108 may be operative to determine one or more spatial parameters of the at least one real-world product. In such embodiments, the one or more spatial parameters may comprise one or more of a distance between objects, a geographical location, an orientation, or any other spatial parameter helpful to identify a physical or virtual location of the at least one real-world product. The distributed ledger 108 may be operative to generate a spatial output based on the one or more spatial parameters. Responsive to a spatial output request, the distributed ledger 108 may then be operative to transmit the spatial output.

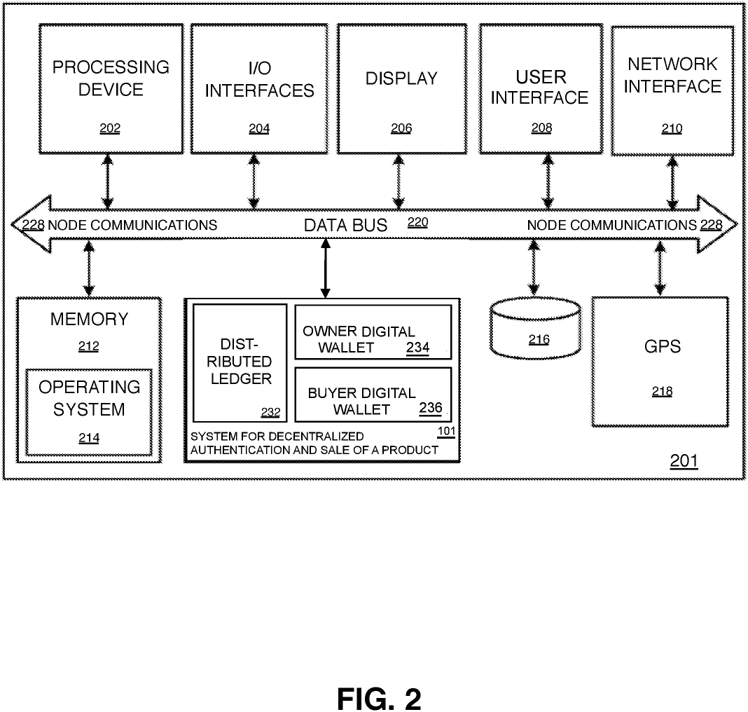

FIG. 2 illustrates an exemplary computing device, which may be the first computing device 102 or the second computing device 104, configured to serve as a node 201 in the system for decentralized authentication and sale of a product. The node 201 may comprise, at least, one processing device (processor) 202, at least one input/output interface 204, at least one display 206, at least one user interface 208, at least one network interface 210, at least one memory 212, at least one operating system 214, at least one mass storage 216, and at least one GPS 218, with each communicating across a local data bus 220. FIG. 2 also discloses the relationship of local data bus 220, the distributed ledger 232 (or, collectively “data blocks”), the at least one owner digital wallet 234, and the at least one buyer digital wallet 236 of the system for decentralized authentication and sale of a product 101. In some embodiments, node 201 may communicate with other node(s) 228 via one or more networks (not shown in FIG. 2). Additionally, the digital product identifier (not pictured) may act as a private key that may enable one or more nodes 201 to access blockchain-encrypted data in an unencrypted or deidentified, or both, form.

As the present invention contemplated a distributed ledger computer system wherein each node 201 may communicate with one or more nodes 201, and in some embodiments, all other nodes 201, one or more elements of node 201 may be absent in any particular node 201 or shared across one or more nodes 201. In some embodiments, while it is contemplated that, generally although not required in every case, each node 201 may store a copy of all cryptocurrency data blocks 232 and their block-chains across the entire present invention, thereby creating a network of secure computing systems and thorough redundancy, one or more other elements may be partially stored on one or more nodes 201, or stored on one node 201 but accessed by another node 201. By way of illustration and not limitation, memory 212 and/or operating system 214 may be partially stored across several nodes 201 but accessed by multiple nodes 201, or may be stored on one or more nodes 201 and accessed by nodes 201 that do not have their own memory 212 and/or operating system 214.

With reference back to FIG. 2, the processing device 202 may include any custom made or commercially available processor, a central processing unit (CPU) or an auxiliary processor among several processors associated with node 201, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 212 may include any one of a combination of volatile memory elements (e.g., random-access memory (RAM, such as DRAM, and SRAM, etc.)) and nonvolatile memory elements. The memory typically comprises native operating system 214, one or more native applications, emulation systems, or emulated applications for any of a variety of operating systems and/or emulated hardware platforms, emulated operating systems, etc. For example, the applications may include application specific software which may comprise some or all the components of node 201. In accordance with such embodiments, the components are stored in memory and executed by the processing device. Note that although depicted separately in FIG. 2, the system, method, and apparatus for decentralized e-commerce 100 may be resident in memory such as memory 212. As mentioned above, in some embodiments, one or more nodes 201 may not have their own memory 212 and/or operating system 214 or may store incomplete memory 212 and/or operating system 214, and may therefore draw upon other nodes 201 for use of one or more memory units 212 and/or operating system elements 214 via node 201 to node 201 communication 228, as discussed herein.

User interface 208 may be configured to detect contact within the display area of the display 206 and may provide such functionality as on-screen buttons, menus, keyboards, etc. that allows users to navigate user interfaces by touch. User interface 208 may also be a keyboard, a mouse, a microphone, a vision tracking system, a motion-capture system, a trackball, or any other known interface with a computing system. For some embodiments, node 201 may also comprise GPS 218 or other means to determine the location of the node 201.

One of ordinary skill in the art will appreciate that the operating system 214 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 2, network interface device 210 comprises various components used to transmit and/or receive data over a networked environment such as depicted in FIG. 1. When such components are embodied as an application, the one or more components may be stored on a non-transitory computer-readable medium and executed by the processing device.

In some embodiments, data blocks stored on the distributed ledger 232 may be stored in one language, generally the user’s native language. In some embodiments, however, the present invention may provide, through memory 212 or any other element of the present invention including elements known to the art but not disclosed in FIG. 2, that the data blocks on the distributed ledger 232 may be translated into a selected language by an end user. For example, the present invention may provide that data blocks on the distributed ledger 232 may be stored in English, but when accessed by a user, by using one or more of computing device(s) 102, 104 to access data blocks via QR code, the data blocks may be translated into the language of the accessing device, here computing device(s) 102 or 104 of FIG. 1. This change may be automated in some embodiments, and may enable users to globally review and appreciate data blocks authenticating their transactions.

Storage information for the exemplary blockchain elements of the present invention, which may encompass all the data for the present invention, as discussed in more detail herein, is generally managed as a series of links or “chains” between blocks, wherein each link to the chain requires a mathematical problem to be solved. Once a node 201 has reached the solution, the next block may be linked or chained to the present cryptocurrency data blocks block 232, thus creating the “blockchain” known in the art. In such embodiments, the distributed ledger may be operative to chain a first new ownership data block to a previous ownership data block. The first new ownership data block may correspond to the transfer of the digital product identifier to the at least one buyer digital wallet. Such chaining may comprise, in some embodiments, recording the hash of a first cryptocurrency data blocks 232 in or on a second cryptocurrency data blocks 232. In some embodiments, therefore, the chain may be traced by examining the corresponding hashes of each cryptocurrency data blocks 232 to make sure that they match as intended.

Continuing with FIG. 2, the genesis cryptocurrency data block 232 may provide for only one hash that may comprise a timestamp (at least) hash of its creation. For all other cryptocurrency data blocks 232, hash(s) may comprise a timestamp (at least) hash of the creation of the present cryptocurrency data block 232 as well as the hash of the previous cryptocurrency data block 232. Thereafter, each cryptocurrency data block 232 may comprise, at least, one or more hash(s), one or more items of cryptocurrency data, and one or more elements of storage information or chaining information. In some embodiments, an identical copy of each cryptocurrency data block 232 may be stored on one or more nodes 201. In some embodiments, an identical copy of each cryptocurrency data block 232 may be stored on each node 201.

In embodiments wherein the contents of the at least one owner digital wallet 234 associated with the at least one real-world product owner and the at least one buyer digital wallet 236 associated with the at least one buyer, content and content interaction information (“content” for brevity) may be stored in blockchain form, similarly, the genesis content block may provide for only one hash that may comprise a timestamp (at least) hash of its creation. For all other content blocks generated from alteration of the content, hash(s) may comprise a timestamp (at least) hash of the creation of the present content block as well as the hash of the previous content block. Thereafter, each content block may comprise, at least, one or more hash(s), one or more items of content data, and one or more elements of storage information or chaining information. In some embodiments, an identical copy of each content block may be stored on one or more nodes 201. In some embodiments, an identical copy of each content block may be stored on each node 201.

Remaining with FIG. 2, the present invention may be, and is contemplated generally to be, configured such that one or more nodes 201 may communicate with each other 228. The node 201 to node 201 communication system 228 provides for and enables one or more redundancy and/or data security protections of the present invention. Using node 201 to node 201 communication system 228, one or more nodes 201 of the present invention may all update the at least one owner digital wallet 234, and the at least one buyer digital wallet 236, chains, hashes, copies of cryptocurrency data blocks, and any other element that the present invention may store on a node 201. One or more nodes 201 may utilize node 201 to node 201 communication system 228 to share one or more storage information, thereby enabling one or more nodes to chain a new cryptocurrency data blocks 232 to a previous cryptocurrency data block 232 or a digital wallet 234, 236 to another digital wallet 234, 236. Additionally, one or more nodes 201 may utilize node 201 to node 201 communication system 228 to share one or more node 201 elements, such as but not limited to, part or all of a node’s 201 at least one processing device (processor) 202, at least one input/output interface 204, at least one display 206, at least one user interface 208, at least one network interface 210, at least one memory 212, at least one operating system 214, at least one mass storage 216, at least one GPS 218, and/or at least one local data bus 220.

The first computing device 102 may be associated with the at least one real-world product owner. In some embodiments, the first computing device 102 may be operative to store at least one real-world product listing. The at least one real-world product listing may correspond to the at least one real-world product. Moreover, the at least one real-world product listing may be stored in the at least one owner digital wallet. The first computing device 102 may also be operative to transmit the at least one real-world product listing.

In certain embodiments, the first computing device 102 may be operative to receive a purchase request. The first computing device 102 may also accept the purchase request. The purchase request may be associated with the at least one real-world product listing. After the first computing device 102 may accept the purchase request, the first computing device 102 may be operative to receive the at least one unit of currency and then, transfer the digital product identifier to the at least one buyer digital wallet. In exchange for the transfer of the digital product identifier, he first computing device 102 may also be operative to receive the at least one unit of currency.

As previously mentioned, the system, method, and apparatus may also comprise the second computing device 104. The second computing device 104 may be operative to store the at least one unit of currency in the at least one buyer digital wallet. In addition, the second computing device 104 may be operative to display the at least one real-world product listing. In some embodiments, the second computing device 104 may be operative to generate the purchase request. In these embodiments, the purchase request may be for the at least one real-world product. The second computing device may also transmit the purchase request to the first computing device 102. After the first computing device 102 accepts the purchase request, the second computing device 104 may be further operative to transfer the at least one unit of currency to the at least one owner digital wallet. Responsive to the first computing device 102 transferring the digital product identifier, the second computing device 104 may be operative to receive and store the digital product identifier in the at least one buyer digital wallet.

In accordance with some embodiments where the distributed ledger 232 may be operative to determine the one or more spatial parameters and generate the spatial output based on the one or more spatial parameters, the second computing device 104 may be operative to generate and transmit the spatial output request. Responsive to the distributed ledger 232 transmitting the spatial output, the second computing device 104 may be operative to receive the spatial output.

In some embodiments, a private key, such as a QR code, may be used by the present invention. When the private key is scanned by, for example and not limitation, one or more of the computing devices 102, 104, the present invention may provide one or more items of cryptocurrency data blocks 232 in an unencrypted form or a form having a mixture of encrypted and intelligible cryptocurrency data blocks 232. Moreover, in certain embodiments, only one private key may be used at a time. In further embodiments, only an authorized user of the computing devices 102, 104 may use the private key. Alternatively, more than one private key may be used at a time. It is contemplated that the user may be able to set preferences within the present invention, or utilize a secondary document such as a wallet card, the determine who or what may utilize the private key, in what manner, and to what extent.

The present invention may provide that when the private key is utilized to access the cryptocurrency data block 232, the present invention may create a new hash within a new cryptocurrency data block 232 that links to the accessed cryptocurrency data block 232 in the manner in the blockchain database art and generally described herein. By creating a linked series of chained cryptocurrency data blocks 232, it is contemplated that the present invention may provide a secure chain of data storage and data records.

In FIG. 2, data is shown progressing in both directions between data bus 220 and the distributed ledger 232 and the digital wallets 234, 236 through the private key or apart from the private key. In some embodiments, the role of the private key is one-directional, wherein the users of the computing devices 102, 104 may utilize the private key to access cryptocurrency data blocks 232, whereupon data bus 220 or any other element of node 201 may transfer one or more elements of cryptocurrency data blocks 232 to the user’s electronic device, such as but not limited to the computing devices 102, 104. In some embodiments, the data flow to the system for decentralized authentication and sale of a product without private key activation.

In order to facilitate the aforementioned functionality, various aspects may be performed by one or more of the first computing device 102, the second computing device 104, or any node 201 which may be but is not limited to the first computing device 102 or the second computing device 104,. In one embodiment, the first computing device 102, the second computing device 104, and/or any node 201 are operative to perform, at least in part, any method or system disclosed herein. Any of the first computing device 102 or the second computing device 104 may serve as a node 201 or carry out one or more node 201 functions.

Moreover, as discussed above, any element of content comprising the digital wallets 234, 236 may be stored on the present invention’s distributed ledger or blockchain database in the same manner as any other data block on the distributed ledger 232. These may include physical or virtual goods, transaction receipts, shipping logs, communication logs, reviews, licenses, and/or contracts, among others.

Additionally, data blocks on the distributed ledger 232 and the digital wallets 234, 236 may interface. For example, were a user to purchase some product listing comprising content in the at least one owner digital wallet 234 with some cryptocurrency acceptable to the parties, the content blocks or separate cryptocurrency data blocks may be updated accordingly. The present invention contemplates that any transaction involving content and any other data blocks may be recorded in the appropriate distributed ledger, such as block chain(s) and/or blockchain database.

Attention is now turned to one or more blockchain-related elements of the present invention. The blockchain paradigm provides a generalized framework for implementing decentralized computer resources. Each computing resource may be thought of as a singleton state-machine that may transition between states via cryptographically-secured transactions. When generating a new state-machine, the nodes encode logic which defines valid state transitions and uploads it onto the blockchain. From there on, the blocks may journal a series of valid transactions that, when incrementally executed with the state from the previous block, morph the state-machine into its current state. In a public chain, the Proof of Work consensus algorithm and its underlying peer-to-peer protocol secure the state-machines’ process and transitioning logic from being tampered, and also share this information with all nodes participating in the system. Nodes may, therefore, query the state machines at any time and obtain a result which is accepted by the entire network with high certainty. This transaction-based state-machine generalization of the blockchain is informally referred to as smart contracts.

Ethereum is one example of an attempt at a full implementation of this idea, which may be known to those skilled in the art. The present invention is not limited to Ethereum, and Ethereum is used herein merely as an illustrative and non-limiting embodiment. Any equivalent(s) or substitution(s) for Ethereum is/are contemplated. Indeed, cryptocurrency native to the system for decentralized e-commerce is contemplated.

In its present form, Ethereum builds into the blockchain a Turing-complete instruction set to allow smart-contract programming and a storage capability to accommodate on-chain state. The flexibility of its programming language may be an important property in the context of rights management. This property may enable advanced functionality (multi-party arbitration, bidding, reputation, etc.) to be coded into the present system, adapting to comply with differences in regulation and changes in stakeholders needs. The present invention may utilize Ethereum’s smart contracts to create intelligent representations of commercial contracts that are stored within individual nodes on the network. The present invention may construct the contracts to contain metadata about the contractual terms, permissions, and data integrity. The blockchain transactions in the present system may carry cryptographically signed instructions to manage these properties. The contract’s state transition functions may carry out policies and enforce data alternation only by legitimate transactions. Such policies may be designed to implement any set of rules which govern particular terms, as long as the policy may be represented computationally. For example, a policy may enforce that separate transactions representing both offer and acceptance are transmitted and received by the system from both buyer users and seller users before transferring ownership of goods and/or services between the parties.

Cryptocurrencies may be generally thought of as digital currency systems that are run on a blockchain and utilize a blockchain financial ledger. The present invention’s cryptocurrency is contemplated to exist as a coin or token that has an assigned value based on its purchase in a cryptocurrency marketplace of the present invention. The assigned value may change based on any number of factors, including but not limited to investor valuation, market conditions, supply, reserve, demand, exchange rates, and so forth.

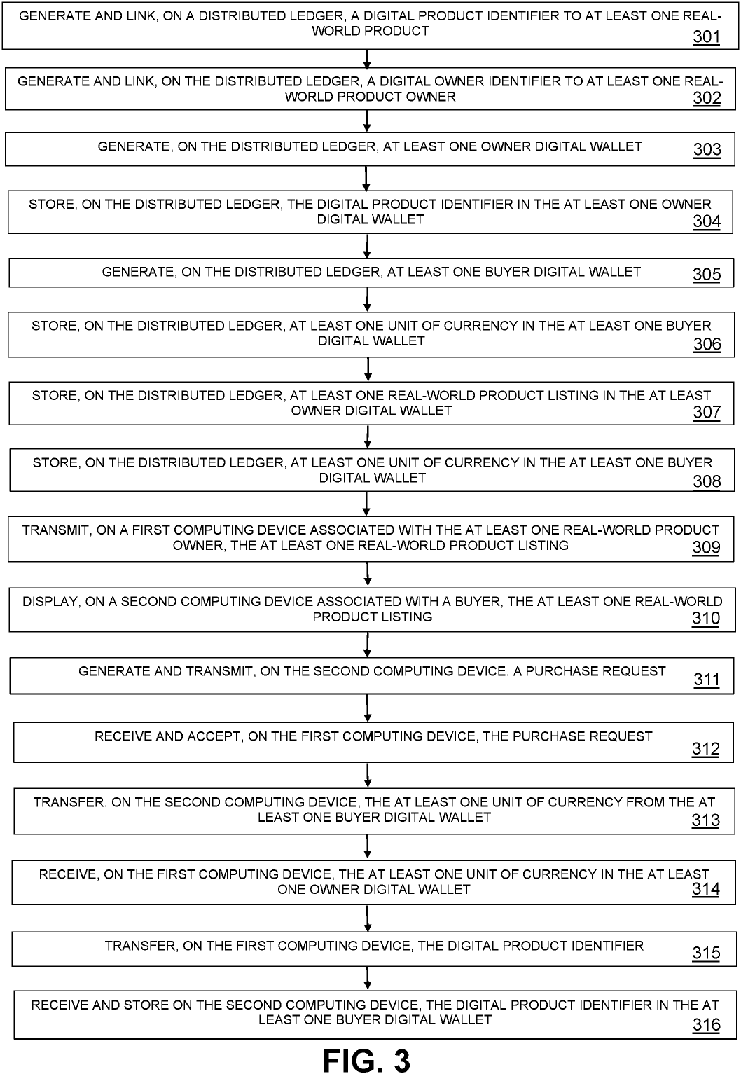

FIG. 3 generally discloses a flowchart depicting an exemplary embodiment of a method for decentralized authentication and sale of a product. In the embodiment shown, a computing system is configured to generate the at least one owner digital wallet and the at least one buyer digital wallet. As shown, the method may comprise the steps of: generating and linking, on a distributed ledger, a digital product identifier to at least one real-world product (block 301); generating and linking, on the distributed ledger, a digital owner identifier to at least one real-world product owner (block 302); generating, on the distributed ledger, at least one owner digital wallet (block 303); storing, on the distributed ledger, the digital product identifier in the at least one owner digital wallet (block 304); generating, on the distributed ledger, at least one buyer digital wallet (block 305); storing, on the distributed ledger, at least one unit of currency in the at least one buyer digital wallet (block 306); storing, on the distributed ledger, at least one real-world product listing in the at least owner digital wallet (block 307); storing, on the distributed ledger, at least one unit of currency in the at least one buyer digital wallet (block 308); transmitting, on a first computing device associated with the at least one real-world product owner, the at least one real-world product listing (block 309); displaying, on a second computing device associated with a buyer, the at least one real-world product listing (block 310); generating and transmitting, on the second computing device, a purchase request (block 311); receiving and accepting, on the first computing device, the purchase request (block 312); transferring, on the second computing device, the at least one unit of currency from the at least one buyer digital wallet (block 313); receiving, on the first computing device, the at least one unit of currency in the at least one owner digital wallet (block 314); transferring, on the first computing device, the digital product identifier (block 315); and receiving and storing, on the second computing device, the digital product identifier in the at least one buyer digital wallet (block 316).

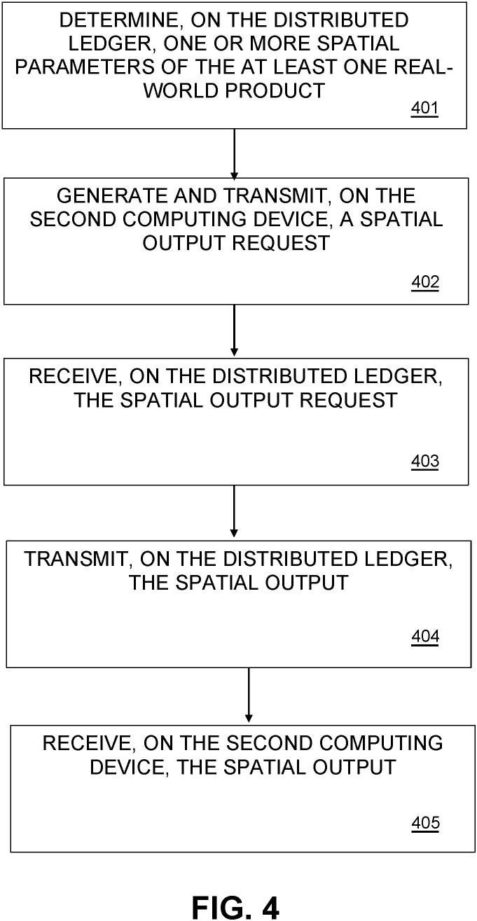

In other embodiments, as shown in FIG. 4, the method may further comprise the steps of: determining, on the distributed ledger, one or more spatial parameters of the at least one real-world product (block 401); generating and transmitting, on the second computing device, a spatial output request (block 402); receiving, on the distributed ledger, the spatial output request (block 403); transmitting, on the distributed ledger, the spatial output (block 404); and receiving, on the second computing device, the spatial output (block 405).

As discussed with regard to the system, above, the distributed ledger may be a blockchain. In such embodiments (not shown), the method may further comprise the steps of: chaining, on the blockchain, a first new ownership data block to a previous ownership data block. The first new ownership data block may correspond to the transfer of the digital owner identifier to the at least one buyer digital wallet.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the distributed ledger may be a blockchain or any other type of distributed ledger. Accordingly, it is intended that the invention not be limited, except as by the appended claims.

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method, and apparatus for decentralized authentication and sale of a product with which that terminology is associated. In general, the terms used in the following claims should not be constructed to limit the system, method, and apparatus for decentralized authentication and sale of a product to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system, method, and apparatus for decentralized authentication and sale of a product is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system, method, and apparatus for decentralized authentication and sale of a product.

What is claimed is:

1. A decentralized computing system for product sale and authentication, comprising
a distributed ledger, operative to
generate and link a digital product identifier to at least one real-world product, wherein the digital product identifier is physically affixed to the at least one real-world product;
generate and link a digital owner identifier to at least one real-world product owner;
generate at least one owner digital wallet;
store the digital product identifier in the at least one owner digital wallet;
generate at least one buyer digital wallet;
store at least one unit of currency in the at least one buyer digital wallet;
determine one or more spatial parameters of the at least one real-world product;
generate a spatial output based on the one or more spatial parameters;
transmit the spatial output responsive to a spatial output request;
a first computing device associated with the at least one real-world product owner, operative to:
store at least one real-world product listing in the at least one owner digital wallet;
transmit the at least one real-world product listing;
receive and accept a purchase request;
receive the at least one unit of currency;
transfer the digital product identifier to the at least one buyer digital wallet;
a second computing device associated with the buyer, operative to
store the at least one unit of currency in the at least one buyer digital wallet;
display the at least one real-world product listing;
generate and transmit the purchase request;
transfer the at least one unit of currency to the at least one owner digital wallet;
receive and store the digital product identifier in the at least one buyer digital wallet.

2. The system of claim 1, wherein the second computing device associated with the buyer is further operative to
generate and transmit the spatial output request; and
receive the spatial output.

3. The system of claim 1, wherein the distributed ledger is further operative to
chain a first new ownership data block to a previous ownership data block,
and wherein the first new ownership data block corresponds to the transfer of the digital owner identifier to the at least one buyer digital wallet.

4. The system of claim 3, wherein the distributed ledger is a blockchain.

5. The system of claim 1, wherein the at least one real-world product is a physical product or a service.

6. The system of claim 5, wherein the physical product is an autographed product comprising at least one autograph.

7. The system of claim 6, wherein the at least one real-world product owner created the at least one autograph.

8. The system of claim 1, wherein the one or more spatial parameters comprise one or more of a distance between objects, a geographical location, and an orientation.

9. A non-transitory, tangible computer-readable medium having stored thereon computer-executable instructions, which, when executed by a computer processor, enable one or more computers coupled to a decentralized network to execute a method for product sale and authentication, the method comprising:
generating and linking, on a distributed ledger, a digital product identifier to at least one real-world product;
generating and linking, on the distributed ledger, a digital owner identifier to at least one real-world product owner;
generating, on the distributed ledger, at least one owner digital wallet;
storing, on the distributed ledger, the digital product identifier in the at least one owner digital wallet;
generating, on the distributed ledger, at least one buyer digital wallet;
storing, on the distributed ledger, at least one unit of currency in the at least one buyer digital wallet;
storing, in the at least owner digital wallet, at least one real-world product listing;
storing, in the at least one buyer digital wallet, at least one unit of currency;
transmitting, on a first computing device associated with the at least one real-world product owner, the at least one real-world product listing;
displaying, on a second computing device associated with a buyer, the at least one real-world product listing;
generating and transmitting, on the second computing device, a purchase request;
receiving and accepting, on the first computing device, the purchase request;
transferring, on the second computing device, the at least one unit of currency;
receiving, in the at least one owner digital wallet, the at least one unit of currency;
transferring, on the first computing device, the digital product identifier; and
receiving and storing, in the at least one buyer digital wallet, the digital product identifier.

10. The computer-implemented method of claim 9, wherein the method further comprises:
determining, on the distributed ledger, one or more spatial parameters of the real-world product;
generating, on the distributed ledger, a spatial output based on the one or more spatial parameters;
generating a transmitting, on the second computing device associated with the buyer, a spatial output request;
receiving, on the distributed ledger, the spatial output request;
transmitting, on the distributed ledger, the spatial output; and
receiving, on the second computing device associated with the buyer, the spatial output.

11. The computer-implemented method of claim 9, wherein the distributed ledger is a blockchain.

12. The computer-implemented method of claim 11, wherein the method further comprises:
chaining, on the blockchain, a first new ownership data block to a previous ownership data block, wherein the first new ownership data block corresponds to the transfer of the digital owner identifier to the at least one buyer digital wallet.

13. The computer-implemented method of claim 9, wherein the at least one real-world product is a physical product or a service.

14. The computer-implemented method of claim 13, wherein the physical product is an autographed product comprising at least one autograph.

15. The computer-implemented method of claim 14, wherein the at least one real-world product owner created the at least one autograph.

16. A method for product sale and authentication, comprising the steps of:
on a distributed ledger,
generating and linking a digital product identifier to at least one real-world product;
generating and linking a digital owner identifier to at least one real-world product owner;
generating at least one owner digital wallet;
storing the digital product identifier in the at least one owner digital wallet;
generating at least one buyer digital wallet;
storing at least one unit of currency in the at least one buyer digital wallet;
storing at least one real-world product listing in the at least owner digital wallet;
storing at least one unit of currency in the at least one buyer digital wallet;
on a first computing device associated with the at least one real-world product owner,
transmitting the at least one real-world product listing;
on a second computing device associated with a buyer,
displaying the at least one real-world product listing;
generating and transmitting a purchase request;
on the first computing device,
receiving and accepting the purchase request;
on the second computing device,
transferring the at least one unit of currency from the at least one buyer digital wallet;
on the first computing device,
receiving the at least one unit of currency in the at least one owner digital wallet;
transferring the digital product identifier; and
on the second computing device,
receiving and storing the digital product identifier in the at least one buyer digital wallet.

17. The method of claim 16, further comprising the steps of
on the distributed ledger,
determining one or more spatial parameters of the at least one real-world product;
generating a spatial output based on the one or more spatial parameters; on the second computing device,
generating and transmitting a spatial output request; on the distributed ledger,
receiving the spatial output request;
transmitting the spatial output; and
on the second computing device,
receiving the spatial output.

18. The method of claim 16, wherein the distributed ledger is a blockchain and the method further comprises the steps of:
on the blockchain,
chaining a first new ownership data block to a previous ownership data block, wherein the first new ownership data block corresponds to the transfer of the digital product identifier to the at least one buyer digital wallet.

19. The method of claim 16, wherein the at least one real-world product is an autographed product comprising at least one autograph.

20. The method of claim 19, wherein the at least one real-world product owner created the at least one autograph.
